(19) United States
(12) Patent Application Publication
(10) Pub. No.: US 2026/0338018 A1
(43) Pub. Date: Oct. 29, 2026

(54) HINGE STRUCTURE

(71) Applicant: KYOCERA Document Solutions Inc., Osaka (JP)

(72) Inventor: Minoru SHINBA, Osaka (JP)

(73) Assignee: KYOCERA Document Solutions Inc., Osaka (JP)

(21) Appl. No.: 19/648,527

(22) Filed: Apr. 15, 2026

(30) Foreign Application Priority Data
Apr. 25, 2025 (JP) 2025-072880

(51) Int. Cl. E05D 11/10; E05D 11/06

(52) U.S. Cl. CPC E05D 11/1078; E05D 11/06

(57) ABSTRACT

A hinge structure includes a turning shaft, a movable-side orthogonal surface, a movable-side projection, a fixed-side orthogonal surface, and a fixed-side projection. The movable-side orthogonal surface faces downward, is provided on an opening/closing member, and is orthogonal to an axial direction of the turning shaft. The movable-side projection is formed on the movable-side orthogonal surface away from the turning shaft. The fixed-side orthogonal surface faces upward, is provided in an apparatus main body, and faces the movable-side orthogonal surface when the opening/closing member is closed. The fixed-side projection is formed on the fixed-side orthogonal surface on a moving locus of the movable-side projection around the shaft. The movable-side projection can ride over the fixed-side projection when a predetermined force is applied to the opening/closing member, and cannot ride over the fixed-side projection when a force smaller than the predetermined force is applied to the opening/closing member.

### INCORPORATION BY REFERENCE

This application is based on and claims the benefit of priority from Japanese patent application No. 2025-072880 filed on Apr. 25, 2025 which is incorporated by reference in its entirety.

### BACKGROUND

The present disclosure relates to a hinge structure which turnably supports an opening/closing member to an apparatus main body.

In an electronic device such as an image forming apparatus, a sheet metal housing storing a controller board and an engine board may be turnably supported by an apparatus main body via a hinge structure. For example, the sheet metal housing can be turned by an open angle of 90 degrees relative to the apparatus main body. When replacing or maintaining an electrical component or a board disposed inside the sheet metal housing, the sheet metal housing is turned to expose the component and the board disposed inside the sheet metal housing. Thus, since it is not necessary to remove the sheet metal housing, the workability of maintenance operation can be improved.

Such a hinge structure may include a turning stopper for the opening/closing member, such as the sheet metal housing. For example, the hinge structure may include the upper and lower cylindrical hinge members externally fitted around the turning shaft. The upper hinge member houses the turning stopper member having a downwardly projecting projection. The turning stopper is biased downward by the spring. The lower hinge member has the hole capable of engaging with the projection. When the upper hinge member is turned relative to the lower hinge member such that the projection reaches the hole, the projection engages with the hole, and the turning of the upper hinge member is therefore restricted.

### SUMMARY

A hinge structure according to the present disclosure turnably supports an opening/closing member to an apparatus main body. The hinge structure includes a turning shaft, a movable-side orthogonal surface, a movable-side projection, a fixed-side orthogonal surface, and a fixed-side projection. The movable-side orthogonal surface faces downward, is provided on the opening/closing member, and is orthogonal to an axial direction of the turning shaft. The movable-side projection is formed on the movable-side orthogonal surface away from the turning shaft. The fixed-side orthogonal surface faces upward, is provided in the apparatus main body, and faces the movable-side orthogonal surface when the opening/closing member is closed. The fixed-side projection is formed on the fixed-side orthogonal surface on a moving locus of the movable-side projection around the tuning shaft. The movable-side projection can ride over the fixed-side projection when a predetermined force along an opening direction or a closing direction is applied to the opening/closing member. The movable-side projection cannot ride over the fixed-side projection when a force smaller than the predetermined force is applied to the opening/closing member.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view showing an image forming apparatus including a hinge structure according to one embodiment of the present disclosure, when viewed from the rear.

FIG. 2 is a perspective view showing the hinge structure according to the embodiment of the present disclosure.

FIG. 3A is a perspective view showing a fixed-side support piece of the hinge structure according to the embodiment of the present disclosure.

FIG. 3B is a perspective view showing a movable-side bracket of the hinge structure according to the embodiment of the present disclosure.

FIG. 4 is a cross-sectional view showing the hinge structure according to the embodiment of the present disclosure.

FIG. 5 is a plan view showing a turning stop rib and a projection in a closed posture and an open posture of the sheet metal housing, in the hinge structure according to the embodiment of the present disclosure.

FIG. 6 is a plan view showing the turning stop rib and the projection in the closed posture and the open posture of the sheet metal housing, in a first modified example of the hinge structure according to the embodiment of the present disclosure.

FIG. 7 is a plan view showing the turning stop rib and the projection in the closed posture and the open posture of the sheet metal housing, in a second modified example of the hinge structure according to the embodiment of the present disclosure.

### DETAILED DESCRIPTION

Hereinafter, with reference to the attached drawings, a hinge structure 1 according to one embodiment of the present disclosure will be described.

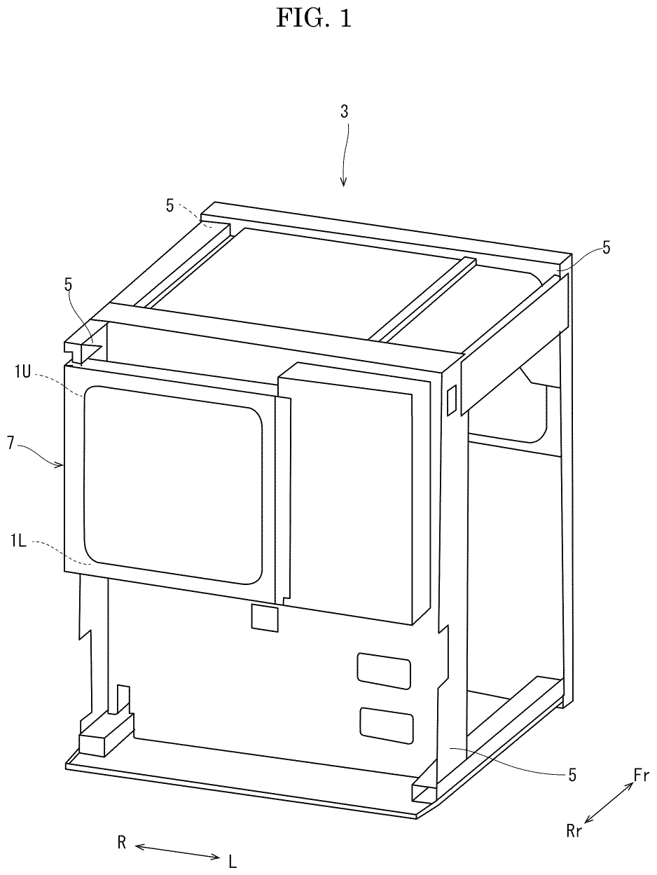

First, with reference to FIG. 1, an image forming apparatus including a hinge structure 1 will be described. FIG. 1 is a perspective view showing an apparatus main body 3 of the image forming apparatus. Fr, Rr, L, and R shown in each figure indicate the front side, rear side, left side, and right side of the apparatus main body 3, respectively.

The image forming apparatus includes the apparatus main body 3 having a substantially rectangular hollow space. The apparatus main body 3 is formed by vertical posts 5 provided at the four corners, a plurality of horizontal posts connecting the adjacent vertical posts 5, a top plate, a bottom plate, left and right side plates, front and rear side plates, and the others. The hollow portion houses an image forming part which forms an image on a sheet by an electrophotographic method.

A sheet metal housing 7 as an opening/closing member is turnably supported on the rear surface of the apparatus main body 3. The sheet metal housing 7 houses a controller board and an engine board which control the image forming operation performed by the image forming part. Specifically, the sheet metal housing 7 is turnably supported by the rear right vertical post 5 of the apparatus main body 3 via upper and lower hinge structures 1U and 1L (collectively referred to as a hinge structure 1). When the sheet metal housing 7 is closed, the hollow space of the apparatus main body 3 is covered with the sheet metal housing 7. On the other hand, when the sheet metal housing 7 is opened to expose the hollow space of the apparatus main body 3, the replacement and maintenance of electrical components, boards, and the others stored in the hollow space can be performed.

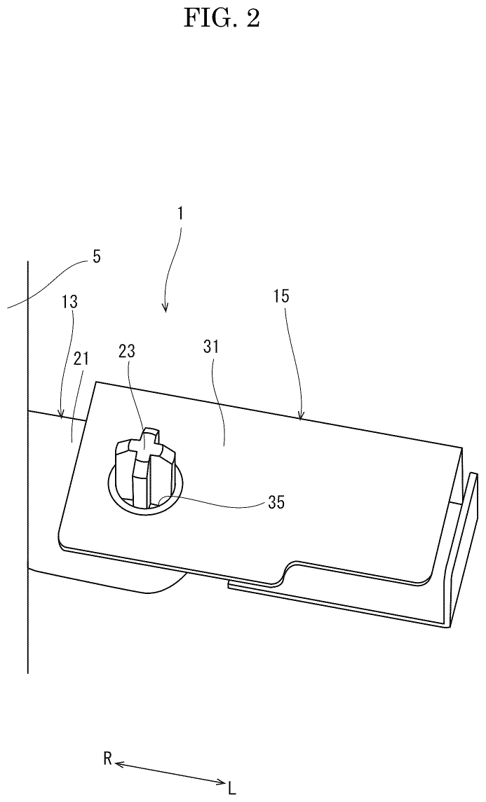

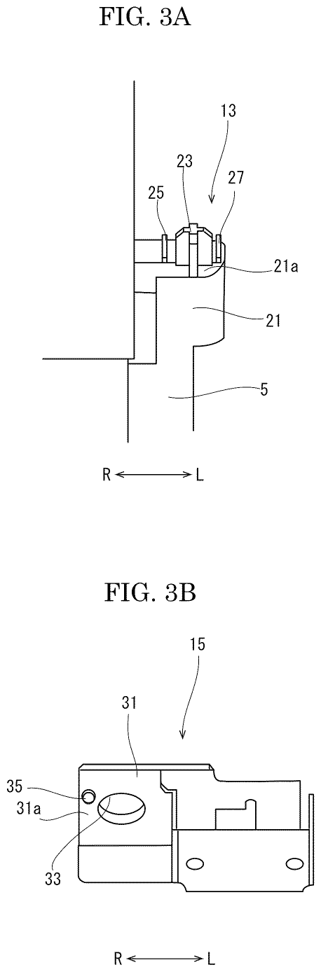

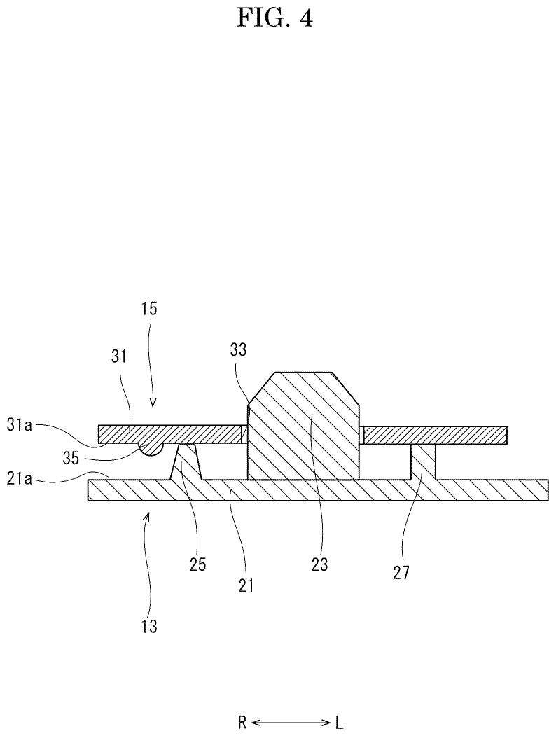

Next, the upper and lower hinge structures 1U and 1L will be described with reference to FIG. 2, FIG. 3A, FIG. 3B, and FIG. 4. FIG. 2 is a perspective view showing the hinge structure 1, FIG. 3A is a perspective view showing a fixed-side support piece 13, FIG. 3B is a perspective view showing a movable-side bracket 15 when viewed from below, and FIG. 4 is a cross-sectional view showing the hinge structure 1. The upper and lower hinge structures 1U and 1L have the same structure.

As shown in FIG. 2, the hinge structure 1 includes a fixed-side support piece 13 fixed to the rear right vertical post 5 of the apparatus main body 3, and a movable-side bracket 15 fixed to the sheet metal housing 7 (not shown in FIG. 2). Here, the turning angle of the sheet metal housing 7 is set to 90 degrees.

First, the fixed-side support piece 13 will be described with reference to FIG. 3A and FIG. 4. The fixed-side support piece 13 is made of sheet metal and has a fixed portion 21 having a horizontal upper surface 21a. A turning shaft 23 extending upward is formed on the upper surface 21a of the fixed portion 21. The turning shaft 23 is formed in a cross shape when viewed from above. Furthermore, on the upper surface 21a of the fixed portion 21, straight ribs 25 and 27 extending in the front-and-rear direction are formed on the right side and the left side of the turning shaft 23, respectively. The right rib 25 is set to the turning stop rib 25, and the left rib 27 is set to the support rib 27. The lengths of both ribs 25 and 27 are equal. Furthermore, as shown in FIG. 4, the heights of both ribs 25 and 27 are equal. Also, the left and right side surfaces of the turning stop rib 25 are inclined upward from the upper surface 21a of the fixed portion 21 at obtuse angles.

Next, the movable-side bracket 15 will be described with reference to FIG. 3B and FIG. 4. The movable-side bracket 15 is made of sheet metal and has a plate-shaped portion 31 having a horizontal lower surface 31a. A circular shaft hole 33 is formed in the plate-shaped portion 31. The diameter of the shaft hole 33 is slightly larger than the outer diameter of the turning shaft 23 of the fixed-side support piece 13. Furthermore, a downwardly projecting hemispherical projection 35 is formed on the lower surface 31a of the plate-shaped portion 31, spaced apart from the shaft hole 33. The height of the projection 35 is lower than the height of the two ribs 25 and 27 of the fixed-side support piece 13. The projection 35 is formed, for example, by drawing the sheet metal. The movable-side bracket 15 is fixed to the sheet metal housing 7 in a posture where the lower surface 31a of the plate-shaped portion 31 is horizontal.

The upper and lower movable-side brackets 15 are positioned above the upper and lower fixed-side support pieces 13, and then the turning shafts 23 of the fixed-side support pieces 13 are inserted into the shaft holes 33 of the movable-side brackets 15, so that the movable-side brackets 15 are turnably coupled to the fixed-side support pieces 13. Further, as shown in FIG. 4, the plate-shaped portion 31 of the movable-side bracket 15 is placed on both ribs 25 and 27 of the fixed-side support piece 13. Consequently, the lower surface 31a of the plate-shaped portion 31 of the movable-side bracket 15 faces the upper surface 21a of the fixed portion 21 of the fixed-side support piece 13 each other in the upper-and-lower direction via the two ribs 25 and 27. Since the heights of the two ribs 25 and 27 are equal, the sheet metal housing 7 is maintained in a horizontal posture via the movable-side brackets 15. The lower surface 31a of the plate-shaped portion 31 of the movable-side bracket 15 and the upper surface 21a of the fixed portion 21 of the fixed-side support piece 13 are examples of the movable-side orthogonal surface and the fixed-side orthogonal surface in the present disclosure. The turning stop rib 25 is an example of the fixed-side projection 25 in the present disclosure, and the projection 35 is an example of the movable-side projection 35 in the present disclosure.

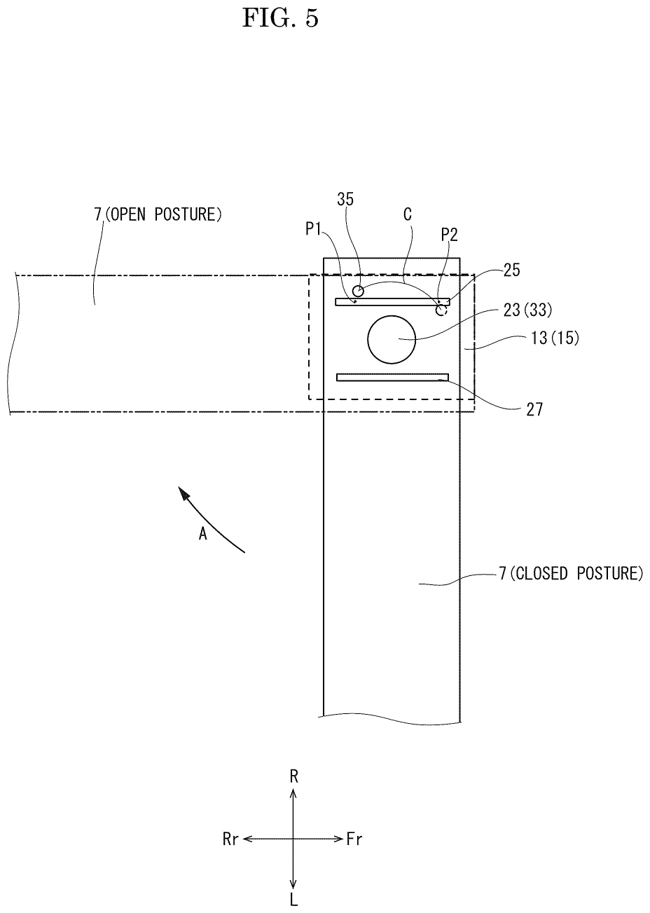

The operation of the hinge structure 1 having the above configuration will be described with reference to FIG. 5. FIG. 5 is a plan view showing the turning stop rib 25 and the projection 35. In FIG. 5, the solid line indicates the sheet metal housing 7 (movable-side bracket 15) in the closed posture, the two-dot chain line indicates the sheet metal housing 7 in the open posture, and the chain line indicates the fixed-side support piece 13. The movable-side bracket 15 turns around the turning shaft 23 (shaft hole 33) within a range of 0 to 90 degrees. The open posture corresponds to the turning angle of 0 degrees, and the closed posture corresponds to the turning angle of 90 degrees.

As shown by the solid line in FIG. 5, in the closed posture, the projection 35 of the movable-side bracket 15 is in contact with the turning stop rib 25 on the downstream side of an opening direction A. When the sheet metal housing 7 is turned, the projection 35 moves along a moving locus (circle C) around the turning shaft 23 (shaft hole 33). Eventually, when the sheet metal housing 7 is turned by nearly 90 degrees, the projection 35 comes into contact with the turning stop rib 25 from the downstream side of the opening direction A. In other words, the turning stop rib 25 is formed on the moving locus (circle C) of the projection 35 around the turning shaft 23 (shaft hole 33).

When a force is applied to the sheet metal housing 7 to turn the sheet metal housing 7 further, as shown in the two-dot chain line in FIG. 5, the projection 35 rides over the turning stop rib 25. Specifically, the projection 35 rides on the top of the turning stop rib 25 along the inclined right side surface (see FIG. 4) and then descends from the top along the inclined left side surface. The sheet metal housing 7 can move slightly upward within the clearance range of the mounting accuracy to the apparatus main body 3. As a result, the sheet metal housing 7 is turned in the open posture.

In this manner, the turning stop rib 25 is formed into a straight line extending in the front-and-rear direction, in which the straight line connects a point P1 in contact with the projection 35 on the upstream side in the opening direction when the sheet metal housing 7 is in the closed posture, and a point P2 in contact with the projection 35 on the downstream side in the opening direction when the sheet metal housing 7 is in the open posture. The position of the projection 35 on the movable-side bracket 15 is determined according to the turning stop rib 25 previously formed on the fixed-side support piece 13. When the turning stop rib 25 is formed in a straight line along the front-and-rear direction on the right side of the turning shaft 23, the projection 35 is formed at a position spaced rearward and rightward from the shaft hole 33 of the movable-side bracket 15 in the state where the sheet metal housing 7 is turned in the closed posture.

After the projection 35 rides over the turning stop rib 25, the force applied to the sheet metal housing 7 is released. Then, inertial force and force due to its own weight act on the sheet metal housing 7. These forces are smaller than the force required to intentionally turn the sheet metal housing 7 in the open or closed directions. Among these forces, when the force in the closing direction is applied, the projection 35 is in contact with the turning stop rib 25, so that the turning of the sheet metal housing 7 in the closing direction is restricted.

When closing the sheet metal housing 7, by applying a predetermined force in the closing direction to the sheet metal housing 7, the projection 35 rides over the turning stop rib 25, so that the sheet metal housing 7 can be turned in the closed posture.

As clear from the above description, according to the present disclosure, the upper and lower hinge structures 1U and 1L enables the sheet metal housing 7 to be maintained in the open posture, so that the replacement and maintenance of electrical components and circuit boards of the image forming part housed in the apparatus main body 3 can be performed without concern for the turning of the sheet metal housing 7. Furthermore, since the apparatus main body 3-side member (fixed-side support piece 13) of the conventional hinge structure 1 only needs to be provided with the turning stop rib 25 and the support rib 27, and the opening/closing member-side member (movable-side bracket 15) only needs to be provided with the projection 35, the configuration is simple and no additional parts are required.

During the turning of the sheet metal housing 7, the movable-side bracket 15 is placed on the two ribs 25 and 27 of the fixed-side support piece 13, so that the contact area between the movable-side bracket 15 and the fixed-side support piece 13 can be minimized. Furthermore, since the two ribs 25 and 27 have the same height, the sheet metal housing 7 can be supported horizontally via the movable-side bracket 15. Therefore, during the turning of the sheet metal housing 7, friction between the movable-side bracket 15 and the fixed-side support piece 13 is reduced, enabling stable turning of the sheet metal housing 7.

Furthermore, since the sheet metal housing 7 is supported by the apparatus main body 3 using the upper and lower hinge structures 1U and 1L so as to be turned more stably relative to the apparatus main body 3.

Furthermore, the side surfaces of the turning stop rib 25 are inclined, so that the projection 35 can be smoothly guided toward the top of the turning stop rib 25 when it rides over the turning stop rib 25.

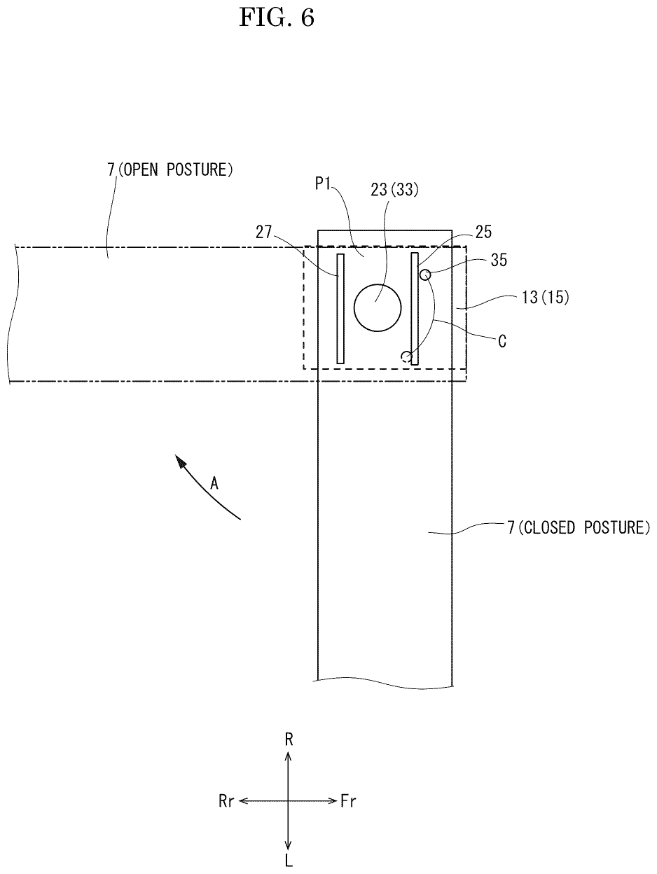

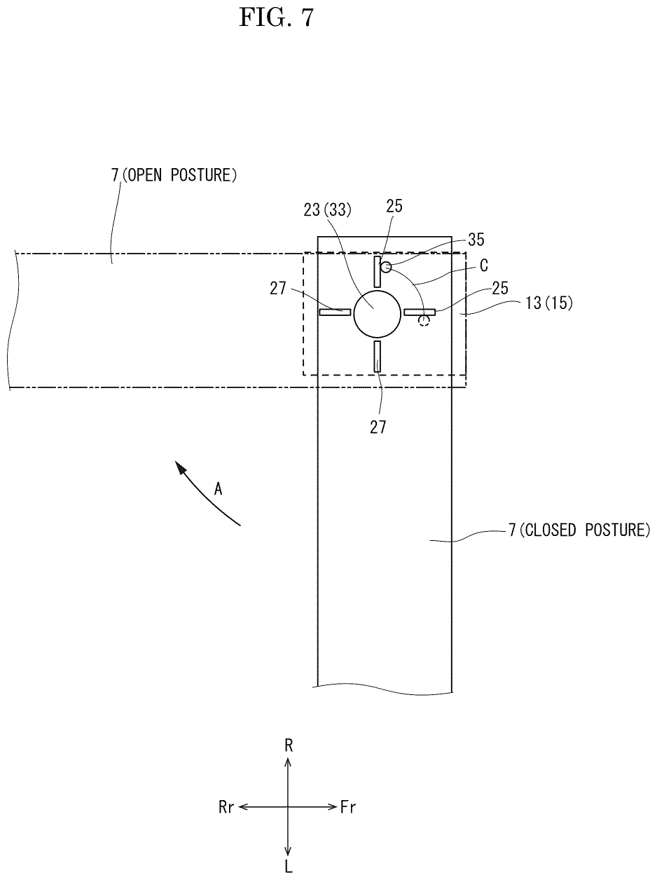

Hereinafter, the first and second modified examples of the hinge structure 1 will be described with reference to FIG. 6 and FIG. 7. The turning stop rib 25 of the hinge structure 1 may be formed at positions other than those described in the above embodiment. The position of the projection 35 is determined according to the position of the turning stop rib 25.

In the first modified example, as shown in FIG. 6, the turning stop rib 25 and the support rib 27 extending in the left-and-right direction are formed on the front and rear sides of the turning shaft 23. In this case, the turning stop rib 25 is formed on the moving locus (circle C) of the projection 35 around the turning shaft 23 (shaft hole 33). The projection 35 of the movable-side bracket 15 is formed at a position spaced apart from the shaft hole 33 in the front and right direction.

Furthermore, a plurality of the turning stop ribs 25 and the support ribs 27 may be provided. In the second modified example, as shown in FIG. 7, the two straight-line turning stop ribs 25 are formed along the radial direction of the turning shaft 23 on the right and front sides of the turning shaft 23. The two straight-line support ribs 27 are formed along the radial direction of the turning shaft 23 on the left and rear sides of the turning shaft 23. In this case, the turning stop ribs 25 are formed on the moving locus (circle C) of the projection 35 around the turning shaft 23 (shaft hole 33). The projection 35 of the movable-side bracket 15 is formed at a position spaced apart from the shaft hole 33 in the front and right direction.

The turning stop rib 25 needs only be formed such that it is in contact with the projection 35 before the sheet metal housing 7 is turned in the open posture. For example, the turning stop rib 25 shown in FIG. 5 may be formed to have only the length of the front half. That is, in the state where the sheet metal housing 7 is turned in the closed position, the turning stop rib 25 needs not necessarily come into contact with the projection 35.

The present disclosure has been described with reference to specific embodiments, but the disclosure is not limited to the above embodiments. The above embodiments may be variously modified, substituted, or transformed without departing from the scope and spirit of the disclosure, and the claims encompass all possible embodiments within the scope of the technical idea. <Appendix 1>

A hinge structure according to Appendix 1 turnably supports an opening/closing member to an apparatus main body, and includes: a turning shaft; a downward-facing movable-side orthogonal surface provided on the opening/closing member and orthogonal to an axial direction of the turning shaft; a movable-side projection formed on the movable-side orthogonal surface away from the turning shaft; an upward-facing fixed-side orthogonal surface provided in the apparatus main body and facing the movable-side orthogonal surface when the opening/closing member is closed; and a fixed-side projection formed on the fixed-side orthogonal surface on a moving locus of the movable-side projection around the turning shaft, wherein the movable-side projection can ride over the fixed-side projection when a predetermined force along an opening direction or a closing direction is applied to the opening/closing member, and the movable-side projection cannot ride over the fixed-side projection when a force smaller than the predetermined force is applied to the opening/closing member.

### Appendix 2

The hinge structure according to Appendix 2 is the hinge structure according to Appendix 1, wherein
the fixed-side projection is formed in a straight shape connecting a point in contact with the movable-side projection on an upstream side in the opening direction when the opening/closing member is closed and a point in contact with the movable-side projection on a downstream side in the opening direction when the opening/closing member is opened.

### Appendix 3

The hinge structure according to Appendix 3 is the hinge structure according to Appendix 1 or 2, and includes:
a support rib which is formed on the fixed-side orthogonal surface of the apparatus main body on the opposite side to the fixed-side projection across the turning shaft and has a same height as the fixed-side projection.

### Appendix 4

The hinge structure according to Appendix 4 is the hinge structure according to Appendix 3, wherein
the fixed-side projection and the support rib have a same length.

### Appendix 5

The hinge structure according to Appendix 5 is the hinge structure according to any one of Appendixes 1 to 4, wherein
the turning shaft is provided along an upper-and-lower direction, and
the hinge structure contains the upper and lower hinge structures.

### Appendix 6

The hinge structure according to Appendix 6 is the hinge structure according to any one of Appendixes 1 to 5, wherein
an upstream side surface and a downstream side surface of the fixed-side projection in the opening direction are inclined toward a top at obtuse angles.

### Appendix 7

The hinge structure according to Appendix 7 is the hinge structure according to any one of Appendixes 1 to 6, wherein,
the movable-side projection is hemispherical.

### Appendix 8

The hinge structure according to Appendix 8 is the hinge structure according to any one of Appendixes 1 to 7, wherein
the predetermined force is a force applied to the opening/closing member for opening or closing the opening/closing member with respect to the apparatus main body.

### Appendix 9

The hinge structure according to Appendix 9 is the hinge structure according to any one of Appendixes 1 to 8, wherein
the opening/closing member is a sheet metal housing which houses electrical components.

What is claimed is:

1. A hinge structure which turnably supports an opening/closing member to an apparatus main body, the hinge structure comprising:
a turning shaft;
a downward-facing movable-side orthogonal surface provided on the opening/closing member and orthogonal to an axial direction of the turning shaft;
a movable-side projection formed on the movable-side orthogonal surface away from the turning shaft;
an upward-facing fixed-side orthogonal surface provided in the apparatus main body and facing the movable-side orthogonal surface when the opening/closing member is closed; and
a fixed-side projection formed on the fixed-side orthogonal surface on a moving locus of the movable-side projection around the turning shaft, wherein
the movable-side projection can ride over the fixed-side projection when a predetermined force along an opening direction or a closing direction is applied to the opening/closing member, and the movable-side projection cannot ride over the fixed-side projection when a force smaller than the predetermined force is applied to the opening/closing member.

2. The hinge structure according to claim 1, wherein
the fixed-side projection is formed in a straight shape connecting a point in contact with the movable-side projection on an upstream side in the opening direction when the opening/closing member is closed and a point in contact with the movable-side projection on a downstream side in the opening direction when the opening/closing member is opened.

3. The hinge structure according to claim 1, comprising:
a support rib which is formed on the fixed-side orthogonal surface of the apparatus main body on the opposite side to the fixed-side projection across the turning shaft and has a same height as the fixed-side projection.

4. The hinge structure according to claim 3, wherein
the fixed-side projection and the support rib have a same length.

5. The hinge structure according to claim 1, wherein
the turning shaft is provided along an upper-and-lower direction, and
the hinge structure contains the upper and lower hinge structures.

6. The hinge structure according to claim 1, wherein
an upstream side surface and a downstream side surface of the fixed-side projection in the opening direction are inclined toward a top at obtuse angles.

7. The hinge structure according to claim 1, wherein,
the movable-side projection is hemispherical.

8. The hinge structure according to claim 1, wherein
the predetermined force is a force applied to the opening/closing member for opening or closing the opening/closing member with respect to the apparatus main body.

9. The hinge structure according to claim 1, wherein
the opening/closing member is a sheet metal housing which houses electrical components.
